(19) United States
(12) Patent Application Publication
(10) Pub. No.: US 2011/0216136 A1
(43) Pub. Date: Sep. 8, 2011

(54) INKJET PRINTER OPERATING A BINARY CONTINUOUS-JET WITH OPTIMUM DEFLECTION AND MAXIMISED PRINT SPEED

(76) Inventors: Bruno Barbet, Etoile/Rhone (FR); Rudy Joly, Bourg Les Valence (FR)

(21) Appl. No.: 13/128,860

(22) PCT Filed: Nov. 10, 2009
(86) PCT No.: PCT/EP09/64911

§ 371 Date: May 11, 2011

Related U.S. Application Data
(60) Provisional application No. 61/118,048, filed on Nov. 26, 2008.

(30) Foreign Application Priority Data
Dec. 11, 2008 (FR) 08 57663

(51) Int. Cl. B41J 2/02

(52) U.S. Cl. 347/75

(57) ABSTRACT

The invention concerns inkjet printers with binary continuous jet, the printing principle of which is based on the differential deflection of jets or jet segments. According to the invention, by virtue of a judicious selection of pulse periods of the electrical generator, the print speed of such printers is optimised while guaranteeing precision of the two deflection levels (binary).

### TECHNICAL FIELD

The invention concerns inkjet printers operating with binary continuous jets, the printing principle of which is based on the differential deflection of jets or segments of jets.

It relates more particularly to the optimisation of the print speed of such printers while guaranteeing precision of the deflection levels.

### PRIOR ART

Ink-jet printing consists of producing and directing ink drops towards a print medium.

Traditionally two different ink-jet printing technologies can be distinguished: drop on demand technology and continuous jet technology. Drop on demand technology is widespread in office printing applications, where the print speed is lower, whereas continuous-jet technology is used widely in the industrial printing field since it guarantees high productivity and good robustness in severe industrial environments. This continuous-jet technology can be broken down into two sub-classes, deviated continuous jet technology (deflection at multiple levels of the drops issuing from the same jet) and binary continuous jet technology (deflection at two levels of the drops issuing from a multitude of jets, which are generally regularly spaced apart and situated in the same plane consisting of an array of jets).

Binary continuous jet technology makes it possible to achieve very high print speeds through the rate of production of the drops (high output of ink, and high-frequency drop production) and the multitude of jets printing in parallel. For the main applications of this technology, the print speed is a key performance. The rate at which so-called printable drops can be produced depends on the principle of generating and deflecting the drops, which give rise to different types of interaction and influence.

The various forms of binary continuous jet technology, according to the drop deflection principles, give rise to specific solutions for maximising the print speed.

The electrostatic deflection of drops is a printing technique that does not make it possible to print all the drops produced because of the phenomenon of electrical interaction between the charged drops in the same jet or between adjacent jets, as well as between the drops and the charging electrodes: in this regard reference can be made to the patent U.S. Pat. No. 4,613,371 from KODAK. In order to discriminate the trajectory of the printed and non-printed drops to the maximum possible extent and to guarantee the print quality through the precision of placement of the impacts, the sequencing of the printed drops obviously depends on the pattern to be printed but it must take account of the charge conditions and interactions between the drops by introducing so called “guard” drops. These guard drops, systematically interposed between the charged drops in order to limit interference, do not make it possible to print at the maximum speed of each jet given by the frequency of generation of the drops and the output of the jet.

The patent U.S. Pat. No. 7,273,270 from KODAK minimizes the electrostatic coupling between drops by offsetting in time the instant of charging of the drops in order to maximise the rate of use of the drops produced by the jet with a view to the printing and thus increase the effective print speed.

The print technology that uses aerodynamic deflection of drops works by placing drops produced with two different diameters on different trajectories. These drops are deviated from their trajectory by an air flow that is transverse to the path of the drops. This printing principle also leads to constraints relating to the formation of the drops and their interactions. Because of this, the use of printable drops must be limited. The patent U.S. Pat. No. 6,505,921 from KODAK describes a particular example of printable drop production logic in order to obtain a good print quality, which in the end limits the printing speed.

Jet deflection is a recent printing technique, as proposed by the applicant in the patent application WO 2008/040777, which makes provision for deflecting continuous jets by exploiting a differential deflection between the printed and non-printed jet segments. In this technique the successive printing of two drops requires the systematic creation of a non-printed section or segment of jet recovered by the gutter in alternation with the printed drops. The length of this jet non-printed section or segment is up till now around the height of the high-voltage electrodes that provide the deflection. This segment or section of ink lost for the printing since it is deviated and recovered by the gutter leads to an effective print speed much lower than the maximum theoretical print speed given by the overall jet output. According to the prior art, the sizing of the deflection electrodes maximises the differential deflection (difference in angular deflection between trajectories of printed and non-printed drops). The major drawback of this approach is not optimising the print speed performance which is however essential in binary continuous jet technology.

An objective of the invention is thus to propose a solution to optimise the speed performance of an ink jet printer which implements the binary continuous jet technology while keeping without changing the binary level of deflection.

### DISCLOSURE OF THE INVENTION

In all the content of the present application, the words “deflection” and “deviation” are synonymous.

FIG. 1 depicts in vertical section part of an ink jet printer according to binary continuous technology. The plane (Y, Z) depicted is orthogonal to the direction of alignment of the nozzles (X), and only one nozzle and the jet issuing from it are therefore shown.

In the framework of the invention, the expression “direction of travel of the jet” means the ink flow direction from the ejection nozzle(s) either of the first jet segments or the second jet segments in a plane (Y, Z).

The word “height” either of a dielectric or an electrode is the dimension of the concerned element which is considered according to the axis Z.

The word “length” is voluntarily chosen different of the word “height”: the length makes reference to the biggest dimension in a plane (Y, Z) of a cylindrical jet segment.

The drop generator 1 is supplied with ink under pressure. This generator comprises a multitude of ink ejection nozzles in parallel (only one of which referenced 2 is shown).

This generator comprises, inside a multitude of stimulation chambers each in hydraulic communication with one of the nozzles 2, a single reservoir common to the stimulation chambers situated upstream of these brings ink under pressure into each stimulation chamber in order to emit an inkjet 5 along the axis of each nozzle 2. Each stimulation chamber also comprises at least one flexible element, the deformation of which is caused by an electromechanical actuator 3 supplied electrically by a drive signal generator 4.

The continuous jet 5 that flows through the nozzle 2 can be divided into segments 6 of variable size according to the periods between the pulses delivered by the electrical generator 4.

A block of electrodes 7 is arranged below the drop generator 1, being offset from the hydraulic axis Z of the jets. This block 7 comprises two deflection electrodes 8, 9 of individual height He separated from each other by a dielectric 10 of height Hd. In print operation, high-voltage electrical signals periodically variable over time and in phase opposition with respect to each other are applied to these two electrodes 8, 9. The block 7 also comprises a pair of earthed electrodes 100 (one situated upstream 101 and the other situated downstream 102 of the deflection electrodes).

A recovery gutter 11 intercepts the sections or segments of jet deviated and not printed 12 while the non-deviated segments intended for the printing 13 are directed towards the medium to be printed, not shown. Alternatively, and without limiting the scope of the invention, it is the deviated jet segments that can be printed while the non-deviated drops are recovered by the gutter.

It is thus possible to schematically break the jet trajectory down into three zones, A, B, C, shown in FIG. 1:
area A, in which the jet faces the earthed electrode 100: it therefore undergoes no or negligible electrical force;
area B, in which the jet is opposite the block 7 of active deflection electrodes 8, 9. The electrostatic pressure is produced by the deflection electrodes supplied with electrical signals in phase opposition. It is exerted on the jet and its resultant produces a greater or lesser deflection force on the segment of the jet opposite the electrode;
area C, in which the jet segments, deviated with the maximum amplitude 12 or not 13, each follows a path that can be termed quasi-rectilinear since it is no longer subjected to any electrostatic field and deflection force.

Up to the present time, it is known that the printing principle makes it necessary to create so-called “long” jet segments 12 with a length sufficient in order to ensure deflection thereof (as well as recovery) and so-called “short” jet segments 6 for printing.

In order to optimise the print speed, the inventors decided to study the influence of the pulse duration or period of the drive signal on the amplitude of deflection of the jet segments for a given drop generator and electrode block. They thus varied the pulse duration, that is to say the time Ti separating two consecutive pulses.

FIG. 2 shows the curve C illustrating the level of deflection of the jet segments according to their length generated by the pulse duration.

This curve is subdivided into three parts:
a curve part C1 for which the deflection is almost zero: this jet segment length is typically less than the height of the dielectric Hd;
a curve part C2: this is a zone of intermediate deflection amplitude in which the more the pulse duration is increased the greater the deflection amplitude; in practice, it turns out that this zone C2 is difficult to use for a given print head since a risk remains that the jet segments thus partially deflected intercept the recovery gutter;
a curve part C3: a zone in which the deflection amplitude is at a maximum.

The inventors found that, for this curve part C3, that is to say beyond a limit segment length of the jet, the maximum deflection amplitude becomes independent of the length of the segment.

They therefore concluded that the operating point allowing a so called maximum print speed the optimum operating point then corresponds to the point denoted Opt in the figure, which is situated at the junction of the two curve parts C2 and C3. Indeed, at this optimal point Opt, the jet segment has the shortest length recovered by the gutter and at the same time a maximum deflection amplitude which is substantially identical to the unbroken continuous jet (level of 100% deflection).

After other tests, they then found experimentally that this optimum point Opt is reached when the value of the pulse duration Ti combined with the jet speed Vj gives a characteristic jet segment length Lc (equal to Ti×Vj) substantially equal to the term 3He+2Hd, as shown on FIG. 2.

In fact, the inventors made the following technical analysis: the maximum amplitude in a given binary inkjet printer is the one of the continuous jet which is non-broken but deflected by all the electrodes of the block of electrodes. In order to reach substantially this value of maximum deflection amplitude for a jet segment, the electrical dipole within said jet segment have to be correctly formed by each pair of two electrodes in phase opposition. It does imply that the length of a jet segment has to be sufficient to complete the distance of a value of 2He+2Hd. In other words, the jet segment according to the invention must advantageously cover two consecutive electrodes.

Besides, the inventors stated, that this theoretical value has to be practically adjusted by taken into account that:
each jet segment tends to have a reduced length progressively and along all its path due to the capillary forces inherent to a given jet of fluid that close the ends to each other;
each electrode tends to induce an extension of its electrostatic field on each side of its edge.

The inventors then conclude that a given correction coefficient a has to be introduced to take into account these phenomena, for each given inkjet printer along all the height of the block of electrodes, i-e up to the exit of the print head and up to the entry of the recovery gutter.

The inventors do conclude that, for having a maximum print speed while keeping a maximum deflection (100% deflection), it was necessary to operate the printer such that the second jet segments, i-e the deviated segments with the maximum amplitude have a height substantially equal to 2*[(1+α)He+Hd], in which α is the correction coefficient.

As experimentally for the inkjet printer according to FIG. 3, α is typically equal to 0.5, which makes a length of 3He+2Hd for the second jet segment.

The use of a printer according to the invention is thus advantageous by using solely the zones C1 and C3. The deflection level is thus almost binary, which greatly facilitates the design and dimensioning for installation of the gutter and more precisely its drop- or jet-intercepting edge, and avoids risks of interference created by drops whose deflection maybe poorly controlled.

Thus, the subject-matter of the invention is an inkjet printer in which during printing operation advantage is taken of this optimum point.

According to the invention, the ink jet printer comprises:
at least one electrical pulse signal generator;
a drop generator comprising at least one ink ejection nozzle, fed with ink under pressure coming from a stimulation chamber in hydraulic communication with the nozzle; at least one flexible element, the deformation of which, caused by an electromechanical actuator supplied electrically by the pulse signal generator, modulates the volume of the stimulation chamber in order to break the continuous ink jet emitted along the axis of each nozzle into segments, and
a block of electrodes offset with respect to the axis (Z) of each nozzle and comprising at least two deflection electrodes, said two deflection electrodes being the nearest from the nozzle and of individual height He separated from each other by a dielectric of height Hd;

in which, in printing operation,:
the two deflection electrodes are supplied by signals in phase opposition and,
the generator delivers to the electromechanical actuator calibrated pulses with:
   a first period less or equal to Tc₁ creating first segments of jet of length less than or equal to a first length hC₁ less than the height Hd of the dielectric so that said first segments are deviated with a minimum amplitude by the deflection electrodes supplied by signals in opposition phase and,
   a second period Tc₃ creating second jet segments, individually alternately with the first jet segments of length less than or equal to hc₁, said second jet segments having a second length hc₃ substantially equal to 2*[(1+α)He+Hd] so that said second segments are deviated with the maximum amplitude, α being a coefficient correction dependent of the extension of the electrostatic field on each side of an electrode and of the capillary forces in the second jet segments over the height of the block.

Starting from the device described with two electrodes, the inventors also found that the number n of electrodes can be increased to 4, 6 . . . so as to increase the amplitude of deflection. The block of electrodes comprises a plurality of n electrodes (pair A, pair B) of individual height He separated individually by a dielectric of height Hd in order to increase the angle of deflection of the deflected jet segments.

Thus, when the deflection level is not sufficient with a single pair of electrodes for diverting the drops at a given distance from the nozzle, the number of electrodes is increased in order to increase the total amplitude of deflection. According to FIG. 4, the jet segment of length h_{c3} is attracted first by the pair of electrodes A and then a second time by the pair of electrodes B, and so on for the successive pairs of electrodes situated opposite the deviated ink segment.

For the principle of printing by inkjet deflection, the invention with the plurality of electrodes n offers the advantages of being able to optimise the parameters of drop production rate (print speed) and the amplitude of the deflection in a relatively independent manner.

In other words, the installation of a plurality n of deflection electrodes (FIG. 4) instead of a single pair of electrodes (FIG. 1) makes it possible to size the print head (a block of electrodes and recovery gutter) in order to satisfy at the same time:
the print speed requirements (high drop production rate)
the requirements for differential amplitude of deflection between the printed and non-printed jet sections or segments;
a binary deflection level to facilitate the placement of the gutter and therefore the recovery of the non-printed jets (or segments).

According to an advantageous variant, the block of electrodes has, in a plane along the height, electrodes in a curved profile such that the distance separating the said profile from the deviated jet segments is substantially constant over the height of the block.

According to a variant complementary to the previous one, the block of electrodes has n electrodes, each pair of consecutive electrodes (n−1, n), at a dimension j from the nozzle at which the second jet segments (12B) passes in front of, defining a height of 2*[(1+α)Heₙ+Hdₙ]ⱼ given by the individual height Heₙ of the electrodes separated from each other by a dielectric of height Hdₙ which is substantially equal of the length (hc₃)ⱼ of the second jet segments.

In other words, the relationship between the spacing between the electrodes and the height of the electrodes will be chosen so that the combined height 2*[(1+α)Heₙ+Hdₙ]ⱼ is less than the length of the jet segment (Hc₃)ⱼ that passes in front at the dimension J defined from the jet ejection nozzle. This combined height is not constant but slightly decreasing because, under the action of the surface tension forces in the jet, the length of the segment (initially cylindrical) tends to reduce as the jet segment contracts and its shape evolves in order to form a spherical drop. Such a change in electrode spacing therefore in some way compensates for the action of the surface tension forces.

According to a variant complementary to the previous two, the distance that separates the breaking point of the jet from the bottom of the dielectric that follows the first electrode in the direction of travel of the jet is less than the length of the deflected jet segment.

In other words, the breaking of the jet that delimits the upstream part of the segment Hc₃ occurs only when the downstream end of the segment Hc₃ covers the first electrode He and the dielectric Hd that extends it. This advantageous configuration makes it possible to deflect the downstream end of the segment Hc₃ with the first electrode (n=1 in FIG. 4). In this way an electrical looping back by the earthed nozzle plate is achieved without waiting to form a dipole by means of the first pair of electrodes (n=1 and n=2 in FIG. 4).

According to a first variant, the jet segments deviated to the minimum extent are those carrying out the printing. The generator can then deliver pulses at the first shorter period for printing. The time between pulses is less than or at maximum equal to Tc₁. The duration of pulses maybe different in order to generate jet segments with different sizes, but all negligibly deviated or to the minimum. By printing drops with variable duration pulses and therefore variable sizes, it is thus possible to create different grey levels for a given printing, and therefore to increase the print quality.

By way of alternative, according to a second variant, the jet segments deviated to the maximum are those carrying out the printing, while the drops that are not or neglibly deflected are recirculated at the gutter.

### BRIEF DESCRIPTION OF THE FIGURES

Other advantages and characteristics will emerge more clearly from a reading of the description given with reference to the figures, among which:

FIG. 1 is a view in section of part of a binary continuous jet printer according to the invention, in the case where the deviated drops are recovered by the gutters;

FIG. 2 shows the experimental curve for the level of deflection of a jet segment as a function of the length of the jet segment generated by variable pulse durations;

FIG. 3 illustrates a preferred embodiment of a printer part according to the invention comprising a plurality of pairs of electrodes;

FIG. 4 illustrates a preferred embodiment of the network of electrodes according to the invention that takes into account the contraction dynamics of the jet segment.

### DETAILED DESCRIPTION OF PARTICULAR EMBODIMENTS

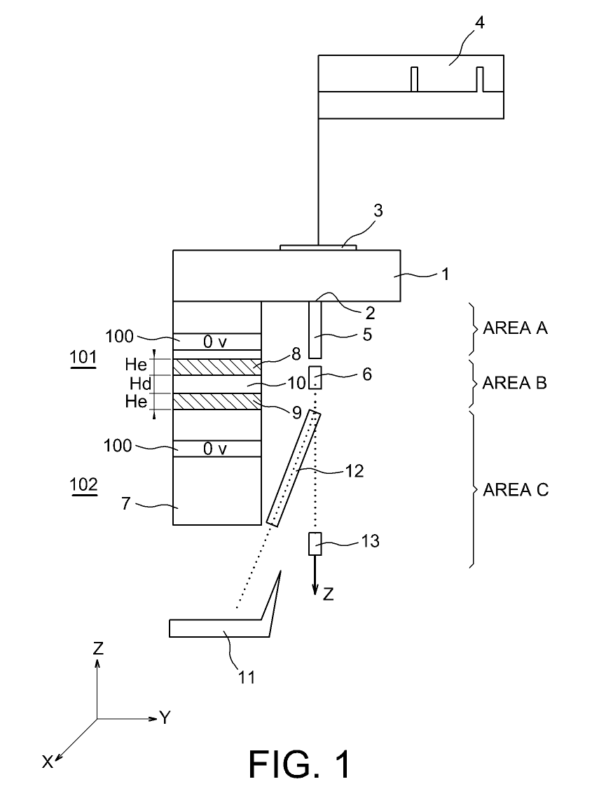

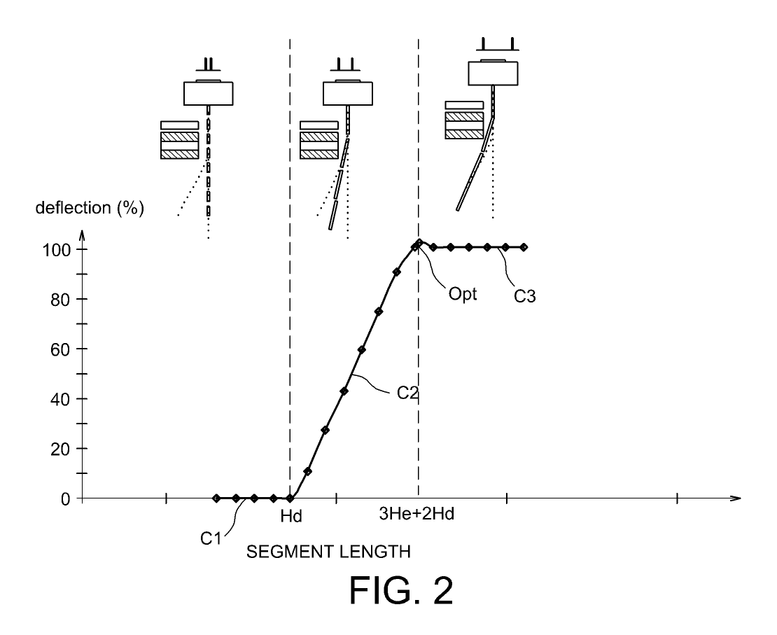

FIGS. 1 and 2 have been commented on in the preamble.

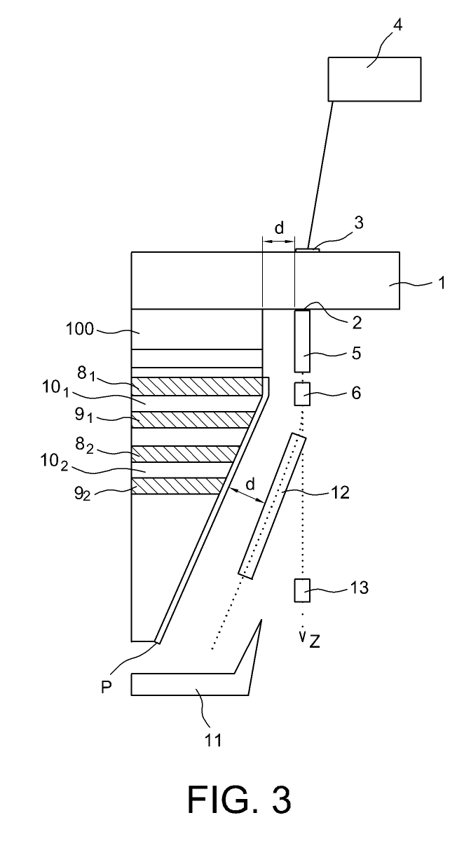

The references in FIGS. 1 and 2 designating the same elements have been repeated in FIG. 3.

FIG. 3 shows a preferred embodiment according to which the block of electrodes 100 comprises two pairs 81, 91 and 82, 92 of individual height He and separated from each other by dielectrics 10₁, 10₂ of identical height Hd.

The block 100 has a curved profile P that enables the deflected jet segments 12 to be at a substantially constant distance from the facing electrodes over the entire height of the block.

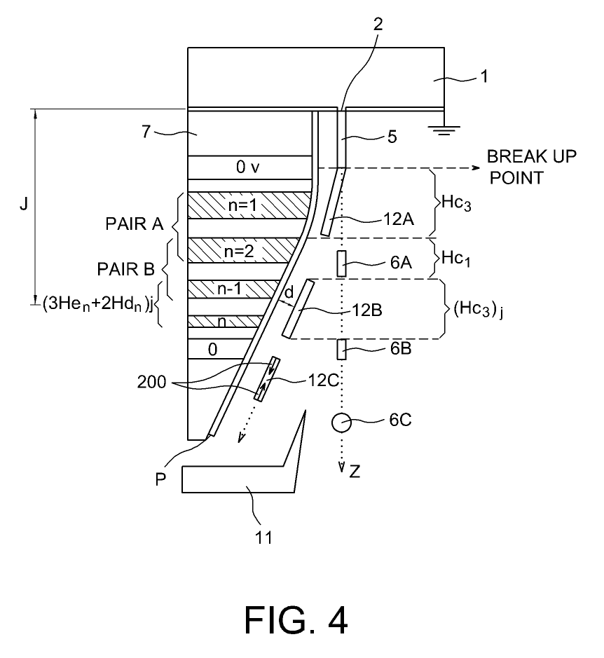

FIG. 4 presents the change in a deflected jet segment whose length tends naturally to decrease under the action of the surface tension 12A, 12B, 12i.

Every end 200 of a given jet segment (12C for example) undergoes a return force (capillary force) that mutually brings the ends together in order in the end to give a spherical shape to the jet segment, initially cylindrical in shape. The length of the segment 12i reducing as it advances in front of the electrodes, it can no longer cover at least two consecutive electrodes and therefore no longer be deflected. It is therefore advantageous to adapt the spacing between the electrodes (dielectric) as well as the height He of the electrodes so that the combined height 2*[(1+α)Heₙ+Hdₙ]ⱼ is less than the length of the jet segment (Hc₃)ⱼ at the dimension J defined from the nozzle 2.

In printing operation, the pulse generator 4 is adjusted so as to alternate deviated and non-deviated drops:
a set of pulses with a first period equal to Tc₁ generates jet segments 6 with a height less than the height of the dielectric Hd and thus creates drops that are very little deviated (with a trajectory at close to zero angle of deflection);
a set of pulses with a second optimum period Tc₃ creates jet segments 12 with a height substantially equal to 3He+2Hd, which are thus deviated with a maximum amplitude comparable to that of the non-fragmented continuous jet.

Such a printer makes it possible to obtain an optimum print speed with the sought-for requirements for binary differential deflection between deviated 12 and non-deviated 13 segments serving for the printing.

In a variant embodiment, in printing operation, the pulse generator 4 is always adjusted so as to alternate the deviated and non-deviated drops, but the set of pulses used to generate the jet segments 6 with a height less than the height of the dielectric Hd and thus create drops that are very little deviated (with an almost zero angle) uses variable durations that may be less than or equal to Tc₁ so as to create drops of variable dimensions less than a maximum dimension given by the pulse duration Tc₁.

In another printing variant, it is the deviated drops that are used for printing, while the drops that are not or only very little deviated are recovered by the gutter. The jet segments intended for printing have lengths substantially not less than or preferably equal to 3He+2Hd, whereas the length of the jet segments recovered is of smaller size, less than Hd.

In the embodiment of the ink jet printer such as shown on FIGS. 2 and 4, the value of the correction coefficient a has been determined experimentally equal to 0.5, a man skilled in the art can determined another coefficient for another ink jet printer by following the experimental method of the inventors explained above by varying the period of impulsions for the drop generator to obtain the optimal point at which the two curves C2 and C3 merge.

1-9. (canceled)

10. An ink jet printer comprising:
at least one electrical pulse signal generator;
a drop generator comprising
at least one ink ejection nozzle which receives ink under pressure from a stimulation chamber in hydraulic communication with the nozzle at least one ejection nozzle; and
at least one flexible element, the deformation of which by an electromechanical actuator supplied electrically by the at least one pulse signal generator, modulates a volume of the stimulation chamber to break a continuous ink jet emitted along an axis Z of each said ejection nozzle into segments; and
a block of electrodes offset with respect to the axis Z of each said ejection nozzle and comprising at least two deflection electrodes, said at least two deflection electrodes being nearest from the nozzle and of an individual height He separated from each other by a dielectric of height Hd,
in which, in a printing operation
the at least two deflection electrodes are adapted to receive signals in phase opposition, and
the drop generator is configured to output to the electromechanical actuator calibrated pulses in which
a first period less than or equal to Tc₁ creating first jet segments each having a length less than or equal to a first length hC₁ less than the height Hd of the dielectric so that said first jet segments are deviated with a minimum amplitude by the at least two deflection electrodes in response to the signals in opposition phase and,
a second period Tc₃ creating second jet segments individually alternately with the first jet segments and of a length less than or equal to hc₁, said second jet segments each having a second length hc₃ substantially equal to 2*[(1+α)He+Hd] so that said second jet segments are deviated with a maximum amplitude, α, being a coefficient correction dependent of an extension of an electrostatic field on each side of an electrode and of the capillary forces in the second jet segments over a height of the block.

11. The ink jet printer according to claim 10, in which the block of electrodes comprises a plurality of n electrodes of individual height He separated individually by dielectrics of height Hd to increase an angle of deflection of the second jet segments.

12. The ink jet printer according to claim 11, in which the block of electrodes has, in a plane along the height of the electrodes, a curved profile such that a distance separating the said profile from the second jet segments is substantially constant over the height of the block.

13. The ink jet printer according to claim 11, in which the block of electrodes has n electrodes, and each pair of consecutive electrodes at a dimension j from the nozzle at which the second jet segments pass in front of, define a height of 2*[(1+α)Heₙ+Hdₙ]ⱼ given by the individual height Heₙ of the electrodes separated from each other by a dielectric of height Hdₙ which is substantially equal to the length (hc₃)ⱼ of the second jet segments.

14. The ink jet printer according to claim 10, in which a distance that separates a breaking point of the jet from a bottom of the dielectric that follows the first electrode in a direction of travel of the jet is less than the length of the deflected jet segment.

15. The ink printer according to claim 10, in which the first jet segments deviated with the minimum amplitude perform the printing during the printing operation.

16. The ink jet printer according to claim 15, in which the generator delivers pulses of the first period less than or equal to Tc₁ that are different in order to generate first jet segments deviated with the minimum amplitude with different sizes.

17. The ink jet printer according to claim 10, in which the first jet segments deviated with the maximum amplitude perform the printing during the printing operation.

18. The ink jet printer according to claim 10, in which the drop generator includes a multitude of ink ejection nozzles in parallel adapted to eject multitude of ink continuous jets in parallel.
